(19) United States
(12) Patent Application Publication
(10) Pub. No.: US 2012/0021083 A1
(43) Pub. Date: Jan. 26, 2012

(54) NON-PLANAR LARGE-SCALE FILM EXTENDING APPARATUS

(75) Inventors: Shia-Chung Chen, Taoyuan County (TW); Ping-Shun Hsu, Taoyuan County (TW); Chia-Yen Tseng, Taoyuan County (TW)

(73) Assignee: CHUNG YUAN CHRISTIAN UNIVERSITY, Taoyuan County (TW)

(21) Appl. No.: 13/188,268

(22) Filed: Jul. 21, 2011

(30) Foreign Application Priority Data
Jul. 22, 2010 (TW) 099124172

(51) Int. Cl. B29C 55/02

(52) U.S. Cl. 425/337

(57) ABSTRACT

A non-planar large-scale film extending apparatus is disclosed, which comprises: a transportation mechanism; and a pressing mechanism; wherein the transportation is used for clamping to two sides of a film and thus expanding the film while enabling the same to be transported and passing through the pressing mechanism following a specific path; and the pressing mechanism is configured with a non-planar pressing surface to be used for pressing upon the film and thus enabling the film being transported by the transportation mechanism to extend uniformly in a manner that the width of the film is increased while allowing the pores on the film to be distributed evenly, and thereby, creating a microporous film with large filtering area.

### CROSS-REFERENCE TO RELATED APPLICATIONS

This non-provisional application claims priority under 35 U.S.C. §119(a) on Patent Application No. 099124172 filed in Taiwan (R.O.C.) on Jul. 22, 2010, the entire contents of which are hereby incorporated by reference.

### FIELD OF THE INVENTION

The present invention relates to an apparatus for extending microporous film, and more particularly, to a non-planar large-scale film extending apparatus capable of extending a film significantly while enabling a plurality of pores to be distributed on the extended film evenly with less manufacturing processes.

### BACKGROUND OF THE INVENTION

Microporous film is a kind of high-tech product that is in great demand today. Especially the fluorine resin films are most popular and vastly used in various products for its distinctive and stable chemical properties. Among those fluorine resin films, the polytetrafluoroethylene (PTFE) film is most common and has best performance in various applications.

Featuring by its high chemical resistance and good filtering ability, the PTFE films are popular in the field of environment protection engineering, biochemical engineering and medication. Nevertheless, with the rapid progress in environment protection engineering, biochemical engineering and medication, PTFE films are found in more and more applications that the technique for producing such multi-functional films is required to be improved for meeting with the rapid growing demand.

Generally, a polymer film is characterized in that: it is easy to process but is disadvantageous in that: it is difficult to control the structure of the polymer film. On the other hand, the fluorine resins, such as PTFE, has orderly symmetrical molecular structure and strong boning force that it is difficult to be processed into thin films comparing with other polymer materials. Consequently, the preparation conditions of the polymer film and operation factor control relating to film manufacturing are the key issues for obtaining a stable film structure with superior performance.

In terms of the PTFE films, the smaller the port diameter of the pores formed on a film by a film production process, the larger the distribution rate of pores will be, and thereby, their will be more types of subject matters capable of being filter by the so-formed film, and thus the usability of the film as well as its value are increased.

Among those film manufacturing processes that are available today, the conventional manufacturing process for uniaxial orientation film production is able to produce a film whose pore diameter can be as low as 0.1±0.02 um. However, in terms of the film production equipments, their developments are restricted by various restrictions, so that the width of film produced by current uniaxial orientation film manufacturing processes can only reach 300 mm, and thus a film whose width is larger than 300 mm can only be produced by biaxial orientation film manufacturing processes.

There are already many researches relating to the biaxial orientation film manufacturing processes, such as the patents disclosed in TW Pat. No. 1247665 and TW Pat. Pub. No. 200736312.

Although the biaxial orientation manufacturing processes can produce films with larger width, the thickness of the biaxial orientation film may be too thin that it is lack of support and thus can not be used in a posterior process for manufacturing filtering devices. Consequently, the resulting biaxial orientation films are most often being laminated to a thicker porous supporting film and thus forming an asymmetrical film before being put into usage.

The process for producing an asymmetrical film starts by the fabricating of the porous supporting film, and then the porous supporting film is laminated with a biaxial orientation film by the use of a thermal press roller so as to form the asymmetrical film that is considered to be a film having a very thin and very refine skin layer formed thereon. Nevertheless, to complete the manufacturing of the asymmetrical film, the aforesaid laminated film should further be processed by a secondary coating procedure. Therefore, the adhering of a coating material on the laminated film and the formation of a coating layer are also importance factors to be considered in the asymmetrical film manufacturing process, and thus there will be additional coating and inspection equipments for the secondary coating procedure that are required in the production of the asymmetrical film. Not only the additional coating and inspection equipments may be costly, but also the performing of the secondary coating procedure may be very time consuming, so that the production of the asymmetrical film is more expensive comparing with the production of uniaxial orientation film.

However, although the biaxial orientation films are still the most popular large-area thin film in the market, the horizontal extension procedure in the biaxial orientation manufacturing process will inevitably cause the resulting biaxial orientation film to have larger average pore diameter and lager pores as well. In addition to the disadvantage of larger pores, by the restriction induced by the devices used for performing the horizontal extension procedure, the pores may not be evenly distributed on the resulting biaxial orientation film. Consequently, the application of such biaxial orientation films for filtering some minute subject matters may not be feasible.

Considering that the production cost of biaxial orientation films is comparatively higher and is disadvantageous in its larger pores that are unevenly distributed, it is in need of an improved manufacturing process for producing biaxial orientation films that are free from the aforesaid shortcomings. That is, it is in need of a manufacturing process for producing large-scale films whose pores are not larger than those of the conventional uniaxial orientation films and also are as evenly distributed as the conventional uniaxial orientation films.

### SUMMARY OF THE INVENTION

In view of the disadvantages of prior art, the primary object of the present invention is to provide a large-scale uniaxial orientation film extending apparatus capable of extending a film significantly while enabling a plurality of pores to be distributed on the extended film evenly with less manufacturing processes.

To achieve the above object, the present invention provides a non-planar large-scale film extending apparatus, which comprises: a transportation mechanism; and a pressing mechanism; wherein the transportation mechanism is used for clamping to two sides of a film and thus expanding the film while enabling the same to be transported and passing through the pressing mechanism following a specific path; and the pressing mechanism is configured with a non-planar pressing surface to be used for pressing upon the film and thus enabling the film being transported by the transportation mechanism to extend uniformly.

By pressing the non-planar pressing surface upon the film, the film being transported by the transportation mechanism is subjected to a force stretching the film uniformly in a biaxial manner for enabling the pores formed on the film to be distributed evenly while the increasing the width of the film, so that the filtering area formed on the film is greatly increased for enhancing the filtering performance of the film.

In a preferred embodiment of the invention, the pressing surface is a curved surface.

In a preferred embodiment of the invention, the pressing surface is formed on a surface of a press component of the pressing mechanism.

In a preferred embodiment of the invention, the press component can be formed as a wheel or a block.

In a preferred embodiment of the invention, the press component is a mobile unit capable of enabling the contact area of the press component with the film to change with the movement thereof.

In a preferred embodiment of the invention, the pressing mechanism has a plurality of press components that are all formed like wheels, but with different outer diameters, and each has a pressing surface formed on the external surface thereof. The plural press components are sorted and arranged in ascending according to their outer diameters, so that when the film is transported passing through the plural press components, it is pressed sequentially by the pressing surfaces of the plural press components in an order of ascending diameter and thus is gradually being extended accordingly.

In a preferred embodiment of the invention, the transportation mechanism has two rows of roller sets, and each roller set in their respective row is composed of two rollers between which the film is clamped, so that the film is being transported forward while having its two sides being respectively clamped by the two rows of the roller sets.

In a preferred embodiment of the invention, the pressing mechanism is constructed with a heating means to be used for heating the pressing surfaces of the pressing components so that the film is heated and softened as it is being fed passing through the heated pressing surfaces so as to facilitate the extending of the film.

In a preferred embodiment of the invention, the film extending apparatus further comprises: a heating box, that is provided for receiving the pressing mechanism therein while enabling the specific path of the film being transported by the transportation mechanism to pass through the heating box, and thereby, the film is heated and softened by the heating box as it is extended by the pressing of the pressing surfaces.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a three-dimensional view of a non-planar large-scale film extending apparatus according to a first embodiment of the invention.

FIG. 2 is a side view of the non-planar large-scale film extending apparatus of FIG. 1.

FIG. 3 is a schematic diagram showing an operating non-planar large-scale film extending apparatus according to the present invention.

FIG. 4 is a schematic diagram illustrating how a film can be extended by the apparatus of the present invention.

FIG. 5 is a side view of a non-planar large-scale film extending apparatus according to a second embodiment of the invention.

FIG. 6 is a side view of a non-planar large-scale film extending apparatus according to a third embodiment of the invention.

FIG. 7 is a side view of a non-planar large-scale film extending apparatus according to a fourth embodiment of the invention.

FIG. 8 is a top view of a non-planar large-scale film extending apparatus according to a fourth embodiment of the invention.

FIG. 9 is a side view of a non-planar large-scale film extending apparatus according to a fifth embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

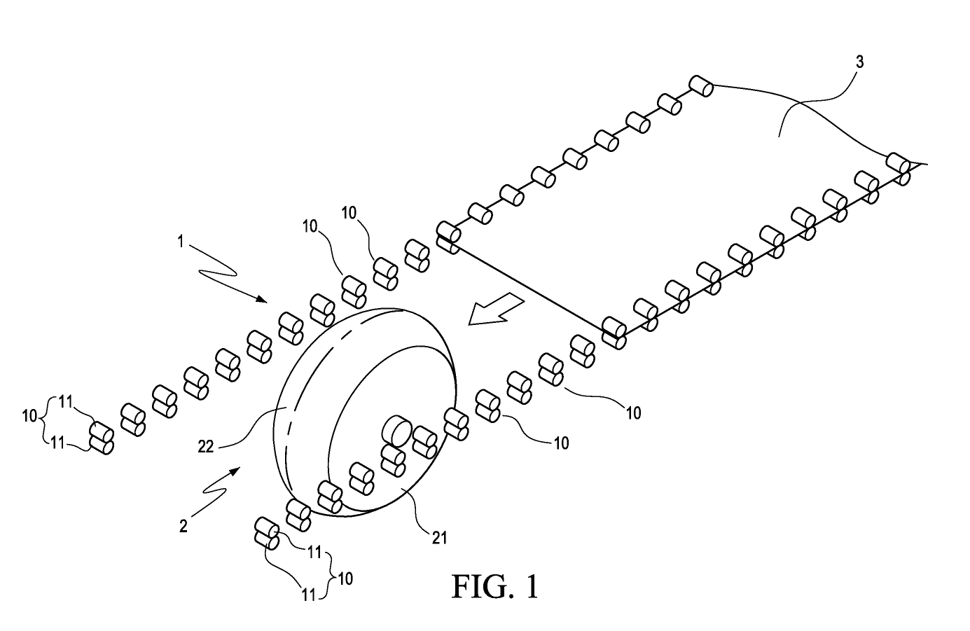

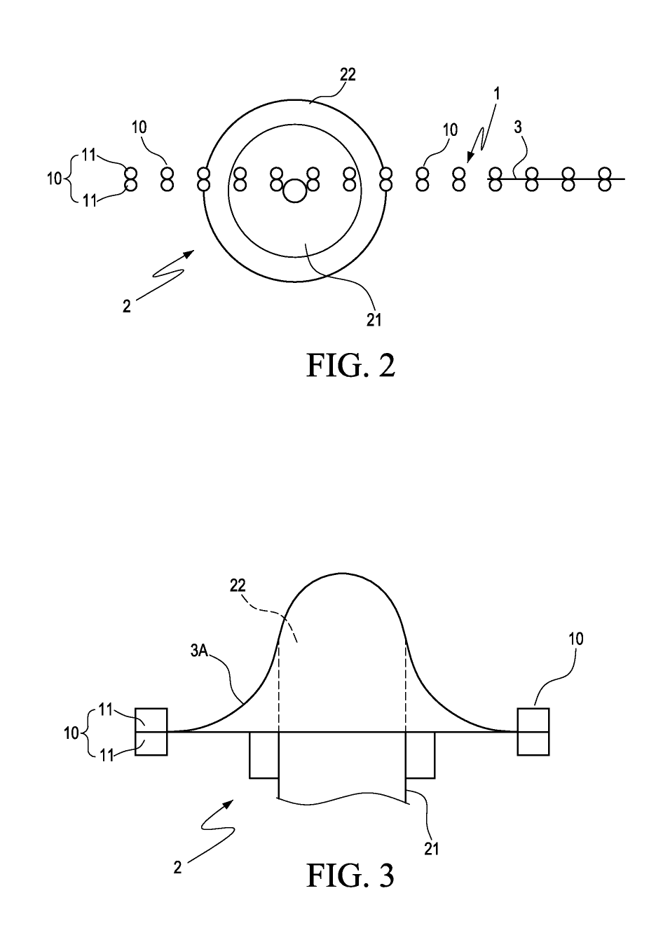

Please refer to FIG. 1 to FIG. 4, which are respectively a three-dimensional view of a non-planar large-scale film extending apparatus according to a first embodiment of the invention; a side view of the non-planar large-scale film extending apparatus of FIG. 1; a schematic diagram showing the operating of non-planar large-scale film extending apparatus of FIG. 1; and a schematic diagram illustrating how a film can be extended by the apparatus of the present invention.

As shown in FIG. 1, a non-planar large-scale film extending apparatus is primarily comprised of: a transportation mechanism 1; and a pressing mechanism 2; in which the transportation mechanism 1 is used for clamping to two sides of a film 3 and thus expanding the film while enabling the same to be transported and passing through the pressing mechanism 2 following a specific path; and the pressing mechanism 2, being configured with a non-planar pressing surface and arranged in the specific path of the film, is used for pressing upon the film 3 and thus enabling the film 3 to be extended thereby.

In this embodiment, the transportation mechanism 1 has two rows of roller sets 10, and each roller set 10 in their respective row is composed of two rollers 11 between which the film 3 is clamped, so that the film 3 is being transported forward while having its two sides being respectively clamped by the two rows of the roller sets 10.

Moreover, the pressing mechanism 2 can substantially be a wheel-like press component 21 that is formed with a curved pressing surface 22 and is arranged in the specific path of the transportation mechanism 1 while enabling the same to extrude out of the specific path. In addition, the pressing mechanism 2 is constructed with a heating means to be used for heating the pressing surface 22 of the press component 21 so that the film 3 is heated and softened as it is being fed passing through the heated pressing surface 22 so as to facilitate the extending of the film 3. In an embodiment of the invention, the heating means is able to heat the pressing surface 22 to a temperature ranged between 150° C. to 250° C.

As shown in FIG. 3, when the film 3 is being transported by the transportation mechanism 1, it will travel passing the extruding pressing surface 22 of the press component 21 that is arranged in the specific path of the transportation mechanism 1, so that the film 3 will be pressed by the non-planar pressing surface 22 for extending the film 3 into an extended film 3A with larger width.

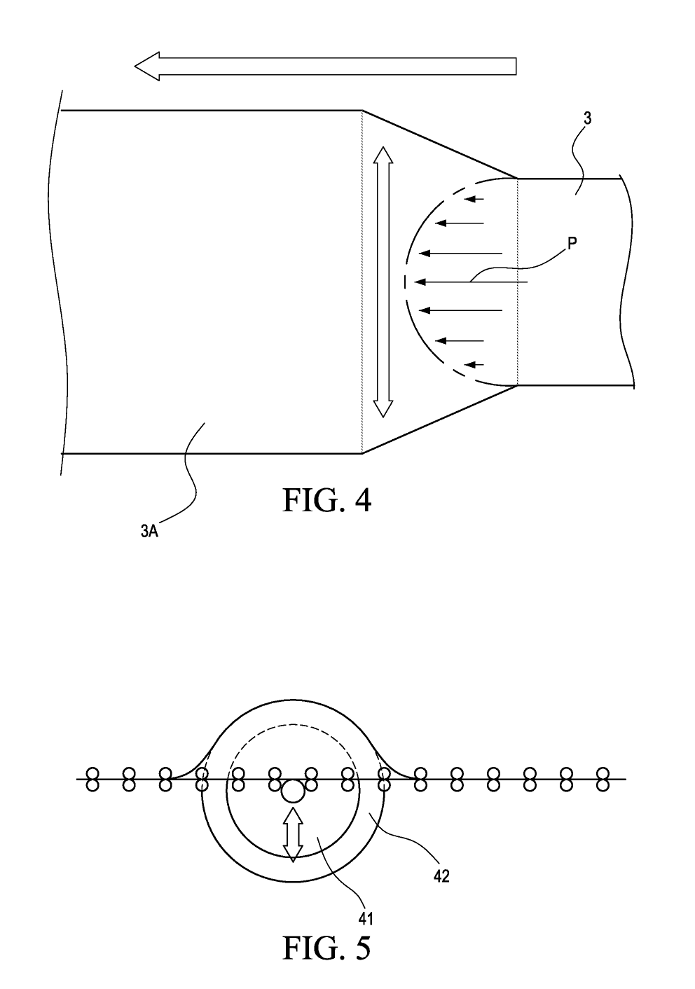

Since the pressing surface 22 of the invention is formed as a curved surface, as shown in FIG. 4, the pressing surface 21 is able to exert a pressure P uniformly upon the film 3 for extending the width thereof. In addition, since the curved pressing surface 22 is designed for extending the film is a biaxial manner that is enforced by the uniformly distributed pressure P from the pressing surface 22 upon the film 3, the pores can be evenly distributed on the resulting film 3A.

Experimentally, the apparatus of the invention can extend the width a PTFE film to about 500 mm, which is a great improvement comparing with those conventional uniaxial orientation films whose width is generally about 300 mm. Thus, the apparatus of the invention can be used for producing films with lager than 500 mm×500 mm filtering area, by that the filtering area formed on the film is greatly increased for enhancing the filtering performance of the film.

Moreover, using the apparatus of the invention, the film can be extended in a single extension operation, so that the manufacturing cost is reduced effectively.

Please refer to FIG. 5, which is a side view of a non-planar large-scale film extending apparatus according to a second embodiment of the invention. As shown in FIG. 5, the press component 41 is a mobile unit capable of enabling the contact area of the press component 41 with the film 3 to change with the movement thereof, i.e. by adjusting the height relating to the extruding of the pressing surface 42 relating to the specific path, the contact area is changed accordingly while achieving a film extending effectiveness the same as the first embodiment.

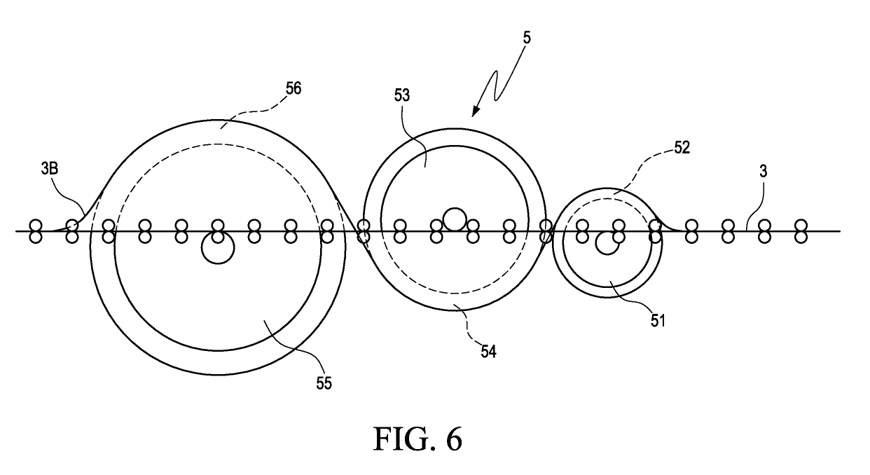

Please refer to FIG. 6, which is a side view of a non-planar large-scale film extending apparatus according to a third embodiment of the invention. As shown in FIG. 6, the pressing mechanism 5 has three press components 51, 53, 55 that are formed as wheels, but with different diameters. The plural press components 51, 53, 55 are sorted and arranged in ascending according to their outer diameters, so that when the film 3 is transported passing through the plural press components 51, 53, 55 sequentially, it is pressed sequentially by the plural press components 51, 53, 55 in an order of ascending diameter and thus is gradually being extended in to film 3B with larger width.

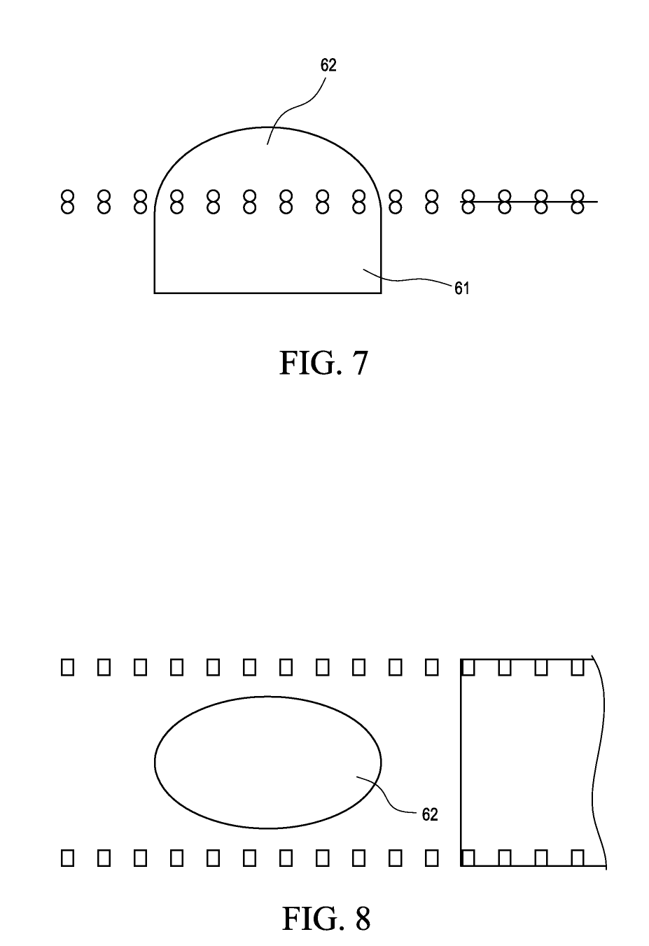

Please refer to FIG. 7 and FIG. 8, which are a side view and a top view of a non-planar large-scale film extending apparatus according to a fourth embodiment of the invention. As shown in FIG. 7 and FIG. 8, the press component 61 is substantially a block whose top is formed with a pressing surface 62 shaped like an ellipsoidal surface, by that the effectiveness of film extending is the same as the first embodiment.

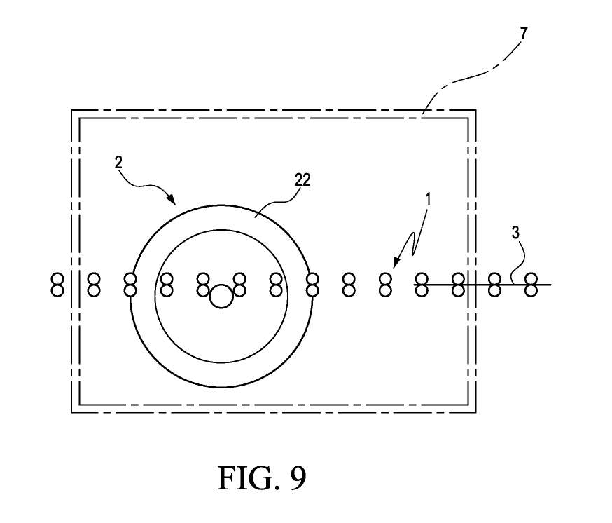

Please refer to FIG. 9, which is a side view of a non-planar large-scale film extending apparatus according to a fifth embodiment of the invention. As shown in FIG. 9, the apparatus of the invention further comprises: a heating box 7, that is provided for receiving the pressing mechanism 2 therein while enabling the specific path of the film 3 being transported by the transportation mechanism 1 to pass through the heating box 7, and thereby, the film 3 is heated to about 150˜250° C. and thus softened as it is extended by the pressing of the pressing surfaces 22 in the pressing mechanism 2. It is noted that the effectiveness of film extending in this embodiment is the same as the first embodiment.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A non-planar large-scale film extending apparatus, comprising:
a transportation mechanism, for clamping to two sides of a film and thus expanding the film while enabling the same to be transported following a specific path; and
a pressing mechanism, configured with a non-planar pressing surface while being arranged in the specific path defined by the film transportation of the transportation mechanism so as to be used for pressing upon the film by its pressing surface and thus enabling the film to extend according to the pressing of the non-planar pressing surface.

2. The non-planar large-scale film extending apparatus of claim 1, wherein the pressing surface is a curved surface.

3. The non-planar large-scale film extending apparatus of claim 1, wherein the pressing surface is formed on a surface of a press component of the pressing mechanism.

4. The non-planar large-scale film extending apparatus of claim 2, wherein the pressing surface is formed on a surface of a press component of the pressing mechanism.

5. The non-planar large-scale film extending apparatus of claim 4, wherein the press component can be formed as a wheel.

6. The non-planar large-scale film extending apparatus of claim 4, wherein the press component can be formed as a block.

7. The non-planar large-scale film extending apparatus of claim 4, wherein the press component is a mobile unit capable of enabling the contact area of the press component with the film to change with the movement thereof.

8. The non-planar large-scale film extending apparatus of claim 1, wherein the pressing mechanism has a plurality of press components that are all formed like wheels, but with different outer diameters, and each has a pressing surface formed on the external surface thereof; and the plural press components are sorted and arranged in ascending according to their outer diameters, so that when the film is transported passing through the plural press components, it is pressed sequentially by the pressing surfaces of the plural press components in an order of ascending diameter and thus is gradually being extended accordingly.

9. The non-planar large-scale film extending apparatus of claim 1, wherein the transportation mechanism has two rows of roller sets, and each roller set in their respective row is composed of two rollers between which the film is clamped, and thereby the film is being transported forward while having its two sides being respectively clamped by the two rows of the roller sets.

10. The non-planar large-scale film extending apparatus of claim 1, wherein the pressing mechanism is constructed with a heating means to be used for heating the pressing surfaces of the pressing components so that the film is heated and softened as it is being fed passing through the heated pressing surfaces so as to facilitate the extending of the film.

11. The non-planar large-scale film extending apparatus of claim 1, further comprising:
a heating box, provided for receiving the pressing mechanism therein while enabling the specific path of the film being transported by the transportation mechanism to pass through the heating box, and thereby, enabling the film to be heated and softened by the heating box as it is extended by the pressing of the pressing surfaces.
